(19) United States
(12) Patent Application Publication
(10) Pub. No.: US 2011/0195317 A1
(43) Pub. Date: Aug. 11, 2011

(54) SOLVENT FOR DISSOLVING ELECTROLYTE SALT OF LITHIUM SECONDARY CELL

(75) Inventors: Meiten Koh, Settsu-shi (JP); Hideo Sakata, Settsu-shi (JP); Hitomi Nakazawa, Settsu-shi (JP); Akiyoshi Yamauchi, Settsu-shi (JP); Hiroyuki Arima, Settsu-shi (JP)

(73) Assignee: DAIKIN INDUSTRIES, LTD., Osaka-shi, Osaka (JP)

(21) Appl. No.: 13/056,599

(22) PCT Filed: Jul. 29, 2009
(86) PCT No.: PCT/JP2009/063475

§ 371 Date: Jan. 28, 2011

(30) Foreign Application Priority Data
Jul. 30, 2008 (JP) 2008-196526

(51) Int. Cl. H01M 10/052; H01M 10/05; H01M 10/0569

(52) U.S. Cl. 429/332; 429/326; 429/330; 429/333

(57) ABSTRACT

A solvent for a non-aqueous electrolytic solution providing a lithium secondary cell being specifically excellent in discharge capacity, rate characteristic and cycle characteristic and having improved incombustibility (safety), a non-aqueous electrolytic solution using the solvent, and further a lithium secondary cell are provided. The solvent for dissolving an electrolyte salt of a lithium secondary cell comprises at least one fluorine-containing solvent (I) selected from the group consisting of fluorine-containing ether, fluorine-containing ester and fluorine-containing chain carbonate, a fluorine-containing aromatic compound (II), in which a part or the whole of hydrogen atoms are replaced by fluorine atoms, and other carbonate (III), the non-aqueous electrolytic solution comprises the solvent and an electrolyte salt, and the lithium secondary cell uses the non-aqueous electrolytic solution.

### TECHNICAL FIELD

The present invention relates to a solvent for dissolving an electrolyte salt of a lithium secondary cell, a non-aqueous electrolytic solution comprising the solvent and an electrolyte salt, and a lithium secondary cell using the non-aqueous electrolytic solution.

### BACKGROUND ART

Demands on characteristics of a non-aqueous electrolytic solution of a lithium secondary cell have been rigidified year by year. One of such demands is to solve a problem with safety (for example, incombustibility and breakdown resistance) at over-charging.

In order to solve this problem, there are known compounds such as biphenyl, cyclohexylbenzene and toluene as an overcharging inhibitor (Patent Documents 1 to 10).

On the other hand, the addition of a fluorine-containing solvent is proposed to enhance incombustibility (flame retardancy) without lowering performance of a non-aqueous electrolytic solution (Patent Documents 11 to 22).

### PRIOR ART DOCUMENTS

### Patent Documents

Patent Document 1: WO 2005/048391
Patent Document 2: JP2004-311442A
Patent Document 3: JP2005-267966A
Patent Document 4: WO 2005/074067
Patent Document 5: JP2003-77478A
Patent Document 6: JP2004-63114A
Patent Document 7: JP2003-132950A
Patent Document 8: JP2004-134261A
Patent Document 9: JP2005-142157A
Patent Document 10: JP2005-259680A
Patent Document 11: JP08-037024A
Patent Document 12: JP09-097627A
Patent Document 13: JP11-026015A
Patent Document 14: JP2000-294281A
Patent Document 15: JP2001-052737A
Patent Document 16: JP11-307123A
Patent Document 17: JP10-112334A
Patent Document 18: WO 2006/088009
Patent Document 19: WO 2006/106655
Patent Document 20: WO 2006/106656
Patent Document 21: WO 2006/106657
Patent Document 22: WO 2008/007734

### DISCLOSURE OF INVENTION

### Problem to be Solved by the Invention

It is an object of the present invention to provide a solvent for a non-aqueous electrolytic solution which provides a lithium secondary cell being excellent specifically in discharge capacity, rate characteristic and further cycle characteristic and has improved incombustibility (safety), a non-aqueous electrolytic solution prepared using the solvent, and further a lithium secondary cell.

### Means to Solve the Problem

The present invention relates to a solvent for dissolving an electrolyte salt of a lithium secondary cell, comprising at least one fluorine-containing solvent (I) selected from the group consisting of a fluorine-containing ether (IA), a fluorine-containing ester (IB) and a fluorine-containing chain carbonate (IC), a fluorine-containing aromatic compound (II), in which a part or the whole of hydrogen atoms are replaced by fluorine atom, and other carbonate (III).

It is preferable, from the viewpoint of improvement in safety, that the fluorine-containing solvent (I) is at least one selected from the group consisting of:

a fluorine-containing ether represented by the formula (IA):

Rf¹ORf²

wherein Rf¹ is a fluorine-containing alkyl group having 3 to 6 carbon atoms, Rf² is a fluorine-containing alkyl group having 2 to 6 carbon atoms,
a fluorine-containing ester represented by the formula (IB):

Rf³COORf⁴

wherein Rf³ is an alkyl group which has 1 or 2 carbon atoms and may have fluorine atom, Rf⁴ is an alkyl group which has 1 to 4 carbon atoms and may have fluorine atom, at least either Rf³ or Rf⁴ is a fluorine-containing alkyl group, and
a fluorine-containing chain carbonate represented by the formula (IC):

Rf⁵OCOORf⁶

wherein Rf⁵ is a fluorine-containing alkyl group having 1 to 4 carbon atoms, Rf⁶ is an alkyl group which has 1 to 4 carbon atoms and may have fluorine atom.

It is preferable that the other carbonate (III) is a cyclic carbonate (IIIA) and a non-fluorine-containing chain carbonate (IIIB), from the viewpoint of good rate characteristic and cycle characteristic.

It is preferable that the cyclic carbonate (IIIA) is one of ethylene carbonate, propylene carbonate and 4-fluoro-1,3-dioxolan-2-one or a mixture thereof, from the viewpoint of good cycle characteristic.

It is preferable that the non-fluorine-containing chain carbonate (IIIB) is one of dimethyl carbonate, methyl ethyl carbonate and diethyl carbonate or a mixture thereof, from the viewpoint of good rate characteristic.

It is preferable that the fluorine-containing aromatic compound (II) is a fluorine-containing aromatic compound obtained by replacing a part or the whole of hydrogen atoms of benzene, toluene, xylene, anisole or biphenyl by fluorine atom since the enhancement of oxidation resistance can be taken into account by bonding fluorine atoms.

It is preferable that the fluorine-containing aromatic compound (II) is monofluorobenzene, difluorobenzene, perfluorobenzene, trifluoromethyl benzene, difluorotoluene, difluoroanisole or fluorobiphenyl, from the viewpoint of good oxidation resistance.

It is preferable that when the total amount of (I), (II) and (III) is assumed to be 100% by volume, the fluorine-containing solvent (I) is contained in an amount of 10 to 90% by volume and the fluorine-containing aromatic compound (II) is contained in an amount of not more than 10% by volume, from the viewpoint of improvement in safety.

It is preferable that when the total amount of (I), (II), (IIIA) and (IIIB) is assumed to be 100% by volume, (I) is contained in an amount of 10 to 60% by volume, (II) is contained in an amount of 0.1 to 10% by volume, (IIIA) is contained in an amount of 10 to 50% by volume, more preferably 10 to 40% by volume and (IIIB) is contained in an amount of 0 to 79.9% by volume, from the viewpoint of improvement in safety and good cell characteristics.

The present invention also relates to a non-aqueous electrolytic solution of a lithium secondary cell comprising the mentioned solvent for dissolving an electrolyte salt and an electrolyte salt.

Further, the present invention relates to a lithium secondary cell using the non-aqueous electrolytic solution of the present invention.

### Effect of the Invention

In the present invention, the fluorine-containing aromatic compound (II), in which a part or the whole of hydrogen atoms is replaced by fluorine atom, exhibits specifically excellent effect of inhibiting heat generation at overcharging and provides improved safety, and by using this fluorine-containing aromatic compound (II) together with the fluorine-containing solvent (I) and the other carbonates (III) such as cyclic carbonate (IIIA) and non-fluorine-containing chain carbonate (IIIB), there can be provided a solvent for a non-aqueous electrolytic solution providing a lithium secondary cell being excellent specifically in discharge capacity, rate characteristic and further cycle characteristic, an electrolytic solution using the solvent and further a lithium secondary cell.

### BRIEF DESCRIPTION OF DRAWINGS

FIG. 1 is a diagrammatic perspective view of the laminate cell prepared in Test 1.

FIG. 2 is a diagrammatic plan view of the laminated cell prepared in Test 1.

FIG. 3 is a graph showing a relation between temperature (° C.) and calorific value (heat flow: mW) measured in Test 1. It is seen that the heat generation starting temperature of Examples 1 and 2 is higher.

### BEST MODE FOR CARRYING OUT THE INVENTION

The solvent for the non-aqueous electrolytic solution of the present invention comprises the fluorine-containing solvent (I), the fluorine-containing aromatic compound (II), in which a part or the whole of hydrogen atoms is replaced by fluorine atom, and the other carbonate (III).

Each component and proportions thereof are explained below.

(I) Fluorine-Containing Solvent (at Least One Selected from the Group Consisting of a Fluorine-Containing Ether (IA), a Fluorine-Containing Ester (IB) and a Fluorine-Containing Chain Carbonate (IC))

By containing the fluorine-containing solvent (I), there can be obtained an action of giving flame retardancy of the electrolytic solution, an action of improving low-temperature characteristics, and an effect of improving rate characteristic and oxidation resistance.

Examples of the fluorine-containing ether (IA) are compounds described in JP8-037024A, JP9-097627A, JP11-026015A, JP2000-294281A, JP2001-052737A, JP11-307123A, etc.

Particularly the fluorine-containing ethers represented by the formula (IA):

Rf¹ORf²

wherein Rf¹ is a fluorine-containing alkyl group having 3 to 6 carbon atoms, Rf² is a fluorine-containing alkyl group having 2 to 6 carbon atoms, are preferred from the viewpoint of good compatibility with other solvents and proper boiling point.

Examples of Rf¹ are fluorine-containing alkyl groups having 3 to 6 carbon atoms such as HCF₂CF₂CH₂—, HCF₂CF₂CF₂CH₂—, HCF₂CF₂CF₂CF₂CH₂—, CF₃CF₂CH₂—, CF₃CFHCF₂CH₂—, HCF₂CF(CF₃)CH₂—, CF₃CF₂CH₂CH₂— and CF₃CH₂CH₂—O—, and examples of Rf² are fluorine-containing alkyl groups having 2 to 6 carbon atoms such as —CF₂CF₂H, —CF₂CFHCF₃, —CF₂CF₂CF₂H, —CH₂CH₂CF₃, —CH₂CFHCF₃ and —CH₂CH₂CF₂CF₃. It is particularly preferable that Rf¹ is an ether having 3 or 4 carbon atoms and Rf² is a fluorine-containing alkyl group having 2 or 3 carbon atoms, from the viewpoint of satisfactory ionic conductivity.

Examples of the fluorine-containing ether (IA) are one or more of HCF₂CF₂CH₂OCF₂CF₂H, CF₃CF₂CH₂OCF₂CF₂H, HCF₂CF₂CH₂OCF₂CFHCF₃, CF₃CF₂CH₂OCF₂CFHCF₃, HCF₂CF₂CH₂OCH₂CFHCF₃ and CF₃CF₂CH₂OCH₂CFHCF₃, and among these, from the viewpoint of good compatibility with other solvents and satisfactory rate characteristic, HCF₂CF₂CH₂OCF₂CF₂H, CF₃CF₂CH₂OCF₂CF₂H, HCF₂CF₂CH₂OCF₂CFHCF₃ and CF₃CF₂CH₂OCF₂CFHCF₃ are especially preferred.

Preferred examples of the fluorine-containing ester (IB) are the fluorine-containing esters represented by the formula (IB):

Rf³COORf⁴

wherein Rf³ is an alkyl group which has 1 or 2 carbon atoms and may have fluorine atom, Rf⁴ is an alkyl group which has 1 to 4 carbon atoms and may have fluorine atom, at least either Rf³ or Rf⁴ is a fluorine-containing alkyl group, from the viewpoint of high flame retardancy and good compatibility with other solvents.

Examples of Rf³ are HCF₂—, CF₃—, CF₃CF₂—, HCF₂CF₂—, CH₃CF₂—, CF₃CH₂—, CH₃— and CH₃CH₂—, and among these, from the viewpoint of satisfactory rate characteristic, CF₃— and HCF₂— are especially preferred.

Examples of Rf⁴ are fluorine-containing alkyl groups such as —CF₃, —CF₂CF₃, —CH₂CF₃, —CH₂CH₂CF₃, —CH(CF₃)₂, —CH₂CF₂CFHCF₃, —CH₂C₂F₅, —CH₂CF₂CF₂H, —CH₂CH₂C₂F₅, —CH₂CF₂CF₃ and —CH₂CF₂CF₂CF₃, and non-fluorine-containing alkyl groups such as —CH₃, —C₂H₅, —C₃H₇ and —CH(CH₃)CH₃, and among these, from the viewpoint of good compatibility with other solvents, —CH₂CF₃, —CH₂C₂F₅, —CH(CF₃)₂, —CH₂CF₂CF₂H, —CH₃ and —C₂H₅ are especially preferred.

Examples of the fluorine-containing ester (IB) are one or more of:

1. fluorine-containing esters, in which both of Rf³ and Rf⁴ are fluorine-containing alkyl groups:
CF₃C(═O)OCH₂CF₃, CF₃C(═O)OCH₂CF₂CF₃, CF₃C(═O)OCH₂CF₂CF₂H, HCF₂C(═O)OCH₂CF₃, HCF₂C(═O)OCH₂CF₂CF₃, HCF₂C(═O)OCF₂CF₂H
2. fluorine-containing esters, in which Rf³ is a fluorine-containing alkyl group:
CF₃C(═O)OCH₃, CF₃C(═O)OCH₂CH₃, HCF₂C(═O)OCH₃, HCF₂C(═O)OCH₂CH₃, CH₃CF₂C(═O)OCH₃, CH₃CF₂C(═O)OCH₂CH₃, CF₃CF₂C(═O)OCH₃, CF₃CF₂C(═O)OCH₂CH₃
3. fluorine-containing esters, in which Rf⁴ is a fluorine-containing alkyl group:
CH₃C(═O)OCH₂CF₃, CH₃C(═O)OCH₂CF₂CF₃, CH₃C(═O)OCH₂CF₂CF₂H, CH₃CH₂C(═O)OCH₂CF₃, CH₃CH₂C(═O)OCH₂CF₂CF₃, CH₃CH₂C(═O)OCH₂CF₂CF₂H,
and among these, the above-mentioned 2. fluorine-containing esters, in which Rf³ is a fluorine-containing alkyl group and 3. fluorine-containing esters, in which Rf⁴ is a fluorine-containing alkyl group are preferred. Among these, CF₃C(═O)OCH₃, CF₃C(═O)OCH₂CH₃, HCF₂C(═O)OCH₃, HCF₂C(═O)OCH₂CH₃, CH₃C(═O)OCH₂CF₃ and CH₃C(═O)OCH₂CF₂CF₃ are especially preferred from the viewpoint of good compatibility with other solvents and satisfactory rate characteristic.

Preferred examples of the fluorine-containing chain carbonate (IC) are fluorine-containing chain carbonates represented by the formula (IC):

Rf⁵OCOORf⁶

wherein Rf⁵ is a fluorine-containing alkyl group having 1 to 4 carbon atoms, Rf⁶ is an alkyl group which has 1 to 4 carbon atoms and may have fluorine atom, from the viewpoint of high flame retardancy and satisfactory rate characteristic.

Examples of Rf⁵ are CF₃—, C₂F₅—, (CF₃)₂CH—, CF₃CH₂—, C₂F₅CH₂—, HCF₂CF₂CH₂— and CF₂CFHCF₂CH₂—, and examples of Rf⁶ are fluorine-containing alkyl groups such as CF₃—, C₂F₅—, (CF₃)₂CH—, CF₃CH₂—, C₂F₅CH₂—, HCF₂CF₂CH₂— and CF₂CFHCF₂CH₂— and non-fluorine-containing alkyl groups such as —CH₃, —C₂H₅, —C₃H₇ and —CH(CH₃)CH₃. Among these, especially preferred Rf⁵ are CF₃CH₂— and C₂F₅CH₂—, and especially preferred Rf⁶ are CF₃CH₂—, C₂F₅CH₂—, —CH₃ and —C₂H₅, from the viewpoint of proper viscosity, good compatibility with other solvents and satisfactory rate characteristic.

Examples of the fluorine-containing chain carbonate (IC) are one or more of fluorine-containing chain carbonates such as CF₃CH₂OCOOCH₂CF₃, CF₃CF₂CH₂OCOOCH₂CF₂CF₃, CF₃CF₂CH₂OCOOCH₃, CF₃CH₂OCOOCH₃ and CF₃CH₂OCOOCH₂CH₃, and among these, from the viewpoint of proper viscosity, high flame retardancy, good compatibility with other solvents and satisfactory rate characteristic, CF₃CH₂OCOOCH₂CF₃, CF₃CF₂CH₂OCOOCH₂CF₂CF₃, CF₃CH₂OCOOCH₃ and CF₃CH₂OCOOCH₂CH₃ are especially preferred. Also, there can be exemplified compounds described, for example, in JP6-21992A, JP2000-327634A and JP2001-256983A.

Among the fluorine-containing solvents (I), the fluorine-containing ether (IA) and the fluorine-containing chain carbonate (IC) are preferred from the viewpoint of proper viscosity, excellent solubility of an electrolyte salt and satisfactory rate characteristic, and especially the fluorine-containing ether (IA) is preferred from the viewpoint of satisfactory cycle characteristic.

The fluorine-containing ether (IA), the fluorine-containing ester (IB) and the fluorine-containing chain carbonate (IC) may be used alone or may be used in combination thereof. In the case of combination use, a combination of (IA) and (IB) and a combination of (IA) and (IC) are preferred from the viewpoint of low viscosity and good compatibility with other solvents.

It is preferable that when the total amount of (I), (II) and (III) is assumed to be 100% by volume, the fluorine-containing solvent (I) is contained in an amount of from 10 to 90% by volume, from the viewpoint of being excellent in an action of giving flame retardancy of the electrolytic solution, an action of improving low-temperature characteristics, and further effects of improving rate characteristic and oxidation resistance. Further, it is preferable that the fluorine-containing solvent (I) is contained in an amount of from 20 to 60% by volume, further from 30 to 50% by volume, especially from 30 to 45% by volume since safety is especially enhanced.

(II) Fluorine-Containing Aromatic Compound, in which a Part or the Whole of Hydrogen Atoms is Replaced by Fluorine Atoms

Examples of the aromatic compound are compounds having an aromatic ring such as benzene ring, naphthalene ring or biphenyl ring comprised of carbon atoms, and the aromatic ring may be subjected to substitution with various kinds of organic groups.

Organic groups as a substituent is not limited particularly, and examples thereof are alkyl groups such as methyl, ethyl and propyl, especially alkyl groups having 1 to 3 carbon atoms; alkoxy groups such as methoxy, ethoxy and propyloxy, especially alkoxy groups having 1 to 3 carbon atoms; phenyl group and the like.

Examples of the aromatic compound are benzene, toluene, xylene, anisole, biphenyl and the like, and among these, benzene, toluene, xylene, anisole and biphenyl are preferred from the viewpoint of good oxidation resistance, and especially benzene, toluene and biphenyl are further preferred since a polymerization reaction occurs at a voltage giving no effect on cell characteristics.

The fluorine-containing aromatic compound to be used in the present invention is a compound obtained by substituting fluorine atom for a part or the whole of hydrogen atoms of the mentioned substituted or un-substituted aromatic compound. Hydrogen atom to be replaced by fluorine atom may be hydrogen atom bonded to an aromatic ring, hydrogen atom bonded to a sub stituent or the both of them.

Specific examples of the fluorine-containing aromatic compounds are fluorobenzene such as monofluorobenzene, difluorobenzene or perfluorobenzene; fluorotoluene such as trifluoromethyl benzene, difluorotoluene or monofluorotoluene; fluoroxylene such as 2-fluoro-m-xylene; fluoroanisole such as difluoroanisole or 2-fluoro-anisole; fluoronaphthalene such as 1-fluoronaphthalene; and biphenyl such as 2-fluorobiphenyl, 4-fluorobiphenyl or 3,3-fluorobiphenyl.

Among these, from the viewpoint of good oxidation resistance, fluorobenzene, fluorotoluene, fluoroanisole and fluorobiphenyl are preferred, and especially fluorobenzene, fluorotoluene and fluorobiphenyl, further, monofluorobenzene, difluorobenzene, perfluorobenzene, trifluoromethyl benzene, difluorotoluene and fluorobiphenyl are preferred.

It is preferable that when the total amount of (I), (II) and (III) is assumed to be 100% by volume, the fluorine-containing aromatic compound (II) is contained in an amount of not more than 10% by volume. When the amount of component (II) is larger beyond the above-mentioned range, there is a tendency that safety is increased, but cell characteristics are lowered. An effect of the component (II) can be exhibited in a relatively small amount. The amount is preferably not more than 5% by volume. An effective lower limit is preferably 0.1% by volume, further preferably 0.5% by volume.

### (III) Other Carbonate

In the present invention, other known carbonate is mixed in addition to (I) and (II). Other carbonate may be chain carbonates or cyclic carbonates, or fluorine-containing carbonates or non-fluorine-containing carbonates other than the fluorine-containing chain carbonate (IC). However, from the viewpoint of good low-temperature characteristics and satisfactory cycle characteristic, the cyclic carbonate (IIIA), the non-fluorine-containing chain carbonate (IIIB), and a mixture thereof are preferred.

### (IIIA) Cyclic Carbonate

The cyclic carbonate (IIIA) may be non-fluorine-containing cyclic carbonate and fluorine-containing cyclic carbonate.

Examples of the non-fluorine-containing cyclic carbonate (IIIA) are one or more of ethylene carbonate, propylene carbonate, butylene carbonate and vinyl ethylene carbonate. Among these, ethylene carbonate (EC) and propylene carbonate (PC) are high in dielectric constant and especially excellent in ability of dissolving an electrolyte salt, and therefore, are preferred for the electrolytic solution of the present invention.

This non-fluorine-containing cyclic carbonate is especially excellent in ability of dissolving an electrolyte salt, and has property of improving rate characteristic and dielectric constant.

Also, it is possible to blend vinylene carbonate as an additional (optional) component for improving cycle characteristic. The amount thereof is desirably 0.1 to 10% by volume based on the whole electrolytic solution.

Examples of the fluorine-containing cyclic carbonate are 4-fluoro-1,3-dioxolan-2-one, 4,5-difluoro-1,3-dioxolan-2-one, 4-trifluoro methyl-1,3-dioxolan-2-one, 4-monofluoromethyl-1,3-dioxolan-2-one, 4,5-dimethyl-4,5-difluoro-1,3-dioxolan-2-one, and 4,5-dimethyl-4-fluoro-1,3-dioxolan-2-one, and especially 4-fluoro-1,3-dioxolan-2-one (monofluoroethylene carbonate) is preferred.

With respect to the cyclic carbonate (IIIA), non-fluorine-containing cyclic carbonate and fluorine-containing cyclic carbonate may be used together.

### (IIIB) Non-Fluorine-Containing Chain Carbonate

Examples of the non-fluorine-containing chain carbonate (IIIB) are one or more of hydrocarbon type chain carbonates such as CH₃CH₂OCOOCH₂CH₃ (diethyl carbonate: DEC), CH₃CH₂OCOOCH₃ (methyl ethyl carbonate: MEC), CH₃OCOOCH₃ (dimethyl carbonate: DMC) and CH₃OCOOCH₂CH₂CH₃ (methyl propyl carbonate). Among these, DEC, MEC and DMC are preferred from the viewpoint of low viscosity and good low-temperature characteristics.

It is preferable that when the total amount of (I), (II) and (III) is assumed to be 100% by volume, cyclic carbonate (IIIA) is contained in an amount of 10 to 50% by volume and the non-fluorine-containing chain carbonate (IIIB) is contained in an amount of 0 to 79.9% by volume, from the viewpoint of further improvement in safety and good cell characteristics.

When the amount of cyclic carbonate (IIIA) is too large, its compatibility with other component is lowered, and there is a case where a phase separation from other component may occur especially at low temperature atmosphere (for example, −30° C. to −20° C.) such as outdoor temperature in wintertime and inside temperature of a refrigerator. From this point of view, a preferred upper limit is 35% by volume, further 30% by volume. On the contrary, when the amount thereof is too small, the ability of the whole solvents for dissolving the electrolyte salt is lowered, and a target concentration (0.8 mole/litter or more) of an electrolyte salt cannot be achieved.

The non-fluorine-containing chain carbonate (IIIB) is low in viscosity and therefore, has an effect of improving low-temperature characteristics. Accordingly, in the case where low-temperature characteristics need to be improved, the non-fluorine-containing chain carbonate may be blended in a proper amount. However, since the non-fluorine-containing chain carbonate is relatively low in flash point, its amount is desirably to be such an extent not to impair safety of the cell.

From the viewpoint mentioned above, preferred solvents for the non-aqueous electrolytic solution are those containing the fluorine-containing solvent (I), especially the fluorine-containing ether (IA) in an amount of 10 to 60% by volume, the cyclic carbonate (IIIA) in an amount of 10 to 50% by volume, the non-fluorine-containing chain carbonate (IIIB) in an amount of 0 to 79.9% by volume and the fluorine-containing aromatic compound (II) in an amount of 0.1 to 10% by volume when the total amount of (I), (II), (IIIA) and (IIIB) is assumed to be 100% by volume. The solvent for the non-aqueous electrolytic solution of the present invention comprises the fluorine-containing solvent (I), the fluorine-containing aromatic compound (II) and the other carbonate (III) as essential components.

For example, when containing no fluorine-containing solvent (I) and using only the fluorine-containing aromatic compound (II) and the other carbonate (III) such as a hydrocarbon solvent, in the case of a voltage being increased, for example, in the case of an over-charge test explained infra, the fluorine-containing aromatic compound (II) is polymerized to form a film on the surface of the electrode and inhibit a reaction with the electrolytic solution, thereby preventing thermorunaway to a certain extent. However, in such a situation not caused due to a voltage, for example, in the case of an over-charge test explained infra, when a separator is broken due to the temperature and an inside short-circuit occurs between the electrodes, the other carbonate (III) is ignited and undergoes firing, and therefore, there is a case where safety is not enough when no fluorine-containing solvent (I) is contained.

Also, when using a non-fluorine-containing aromatic compound but not the fluorine-containing aromatic compound (II), by blending the fluorine-containing solvent (I), the electrolytic solution itself is hardly fired and safety is increased, but since an oxidation potential of the non-fluorine-containing aromatic compound is inherently low, the compound is polymerized, for example, during a charge and discharge cycle, and in some cases, cell characteristics are lowered.

In the solvent for dissolving a non-aqueous electrolytic solution of the present invention, the target problem of the present invention can be solved only by the use of the components (I), (II) and (III), but other solvents known as the solvents for the non-aqueous electrolytic solution may be further blended. Kinds and amounts of such solvents need to be an extent not to impair the solution of the problem of the present invention.

The present invention also relates to the electrolytic solution for a lithium secondary cell comprising the solvent for a non-aqueous electrolytic solution of the present invention and an electrolyte salt.

Examples of the electrolyte salt to be used for the non-aqueous electrolytic solution of the present invention are LiClO₄, LiAsF6, LiBF₄, LiPF₆, LiN(SO₂CF₃)₂, LiN(SO₂C₂F₅)₂ and the like, and from the viewpoint of good cycle characteristic, LiPF₆, LiBF₄, LiN(SO₂CF₃)₂, LiN(SO₂C₂F₅)₂ and combination thereof are especially preferred.

In order to secure practical performance of the lithium secondary cell, the concentration of the electrolyte salt of not less than 0.5 mole/liter, further not less than 0.8 mole/liter is demanded. An upper limit is usually 1.5 mole/liter. The solvent for dissolving an electrolyte salt of the present invention has ability of dissolving an electrolyte salt at a concentration satisfying these requirements.

To the non-aqueous electrolytic solution of the present invention may be added additives such as a flame retardant, a surfactant, an additive for increasing dielectric constant, a cycle characteristic and rate characteristic improver and an over-charging inhibitor without deviation from the specified volume percentages of the components (I), (II) and (III) to an extent not to impair the effect of the present invention.

With respect to a flame retardant, known flame retardants can be used. Especially a phosphoric ester may be added to impart incombustibility (non-ignition property). Ignition can be prevented by mixing a phosphoric ester in an amount of from 1 to 10% by volume based on the solvent for dissolving an electrolyte salt.

Examples of the phosphoric ester are fluorine-containing alkylphosphoric ester, non-fluorine-containing alkylphosphoric ester and arylphosphoric ester, and fluorine-containing alkylphosphoric ester is preferred since it highly contributes to make the electrolytic solution nonflammable and an effect of making the electrolytic solution nonflammable is increased even if its amount is small.

Examples of the fluorine-containing alkylphosphoric ester are fluorine-containing dialkylphosphoric esters disclosed in JP11-233141A, cyclic alkylphosphoric esters disclosed in JP11-283669A, and fluorine-containing trialkylphosphoric esters.

Since the fluorine-containing trialkylphosphoric esters have high ability of giving incombustibility and satisfactory compatibility with the components (I), (II) and (III), the amount thereof can be decreased, and even when the amount is from 1 to 8% by volume, further from 1 to 5% by volume, ignition can be prevented.

Preferred examples of the fluorine-containing trialkylphosphoric esters are those represented by the formula: (RfO)₃—P═O, wherein Rf is CF₃—, CF₃CF₂—, CF₃CH₂—, HCF₂CF₂— or CF₃CFHCF₂—. Especially, tri-2,2,3,3,3-pentafluoropropyl phosphate and tri-2,2,3,3-tetrafluoropropyl phosphate are preferred.

Further, fluorine-containing lactone and fluorine-containing sulfolane can also be exemplified as a flame retardant.

A surfactant may be added in order to improve capacity property and rate characteristic.

Any of cationic surfactants, anionic surfactants, nonionic surfactants and amphoteric surfactants may be used as a surfactant, and fluorine-containing surfactants are preferred from the viewpoint of good cycle characteristic and rate characteristic.

For example, there are preferably exemplified fluorine-containing carboxylates and fluorine-containing sulfonates.

Examples of fluorine-containing carboxylates are HCF₂C₂F₆COO⁻Li⁺, C₄F₉COO⁻Li⁺, C₅F₁ᵢCOO^{-Li}⁺, C₆F₁₃COO⁻Li⁺, C₇F₁₅COO⁻Li⁺, HCF₂C₂F₆COO⁻NH₄⁺, C₄F₉COO⁻NH₄⁺, C₅F₁₁COO⁻NH₄⁺, C₆F₁₃COO⁻NH₄⁺, C₇F₁₅COO⁻NH₄⁺, C₈F₁₇COO⁻NH₄⁺, HCF₂C₂F₆COO⁻NH(CH₃)₃⁺, C₄F₉COO⁻NH(CH₃)₃⁺, C₅F₁₁COO⁻NH(CH₃)₃⁴, C₆F₁₃COO⁻NH(CH₃)₃⁴, C₇F₁₅COO⁻NH(CH₃)₃⁴, C₈F₁₇COO^{-xNH(CH}₃)₃⁺, and the like. Examples of fluorine-containing sulfonates are C₄F₉SO₃⁻Li⁺, C₆F₁₃SO₃⁻Li⁺, C₈F₁₇SO₃⁻Li⁺, C₄F₉SO₃⁻NH₄⁺, C₆F₁₃SO₃⁻NH₄⁺, C₈F₁₇SO₃⁻NH₄⁺, C₄F₉SO₃⁻NH(CH₃)₃⁺, C₆F₁₃SO₃⁻NH(CH₃)₃⁺, C₈F₁₇SO₃⁻NH(CH₃)₃⁺, and the like.

The amount of surfactant is preferably from 0.01 to 2% by mass based on the whole solvents for dissolving the electrolyte salt from the viewpoint of decreasing a surface tension of the electrolytic solution without lowering charge and discharge cycle characteristic.

Examples of an additive for increasing dielectric constant are sulfolane, methyl sulfolane, γ-butyrolactone, γ-valerolactone, acetonitrile, propionitrile and the like.

In the present invention, other overcharging inhibitors may be used together. Examples of other overcharging inhibitor are cyclohexylbenzene, dichloroaniline, difluoroaniline, toluene, and the like. When the amount thereof is large, there is a high possibility of lowering cell characteristics, and therefore, it is desirable to add to an extent not to impair cell characteristics.

For improving rate characteristic, tetrahydrofuran, silicate compounds and the like are effective. In addition, it is effective to add vinylene carbonate for improving cycle characteristic and to add 1,2-dialkyl-1,2-difluoroethylene carbonate for inhibiting generation of gas during storing.

The present invention also relates to the lithium secondary cell using the non-aqueous electrolytic solution of the present invention. The lithium secondary cell of the present invention is provided with a positive electrode, a negative electrode, a separator and the electrolytic solution of the present invention, and it is especially preferable that an active material for the positive electrode to be used on the positive electrode is at least one selected from the group consisting of cobalt compound oxides, nickel compound oxides, manganese compound oxides, iron compound oxides and vanadium compound oxides, since a high output lithium secondary cell having high energy density is obtained.

An example of cobalt compound oxide is LiCoO₂, an example of nickel compound oxide is LiNiO₂, and an example of manganese compound oxide is LiMnO₂. Also there may be used compound oxides of CoNi represented by LiCOₓNi₁₋ₓO₂ (0<x<1), compound oxides of CoMn represented by LiCoₓMn₁₋ₓO₂ (0<x<1), compound oxides of NiMn represented by LiNiₓMn₁₋ₓO₂ (0<x<1) and LiNiₓMn₂₋ₓO₄ (0<x<2) and compound oxides of NiCoMn represented by LiNi_{1-xy}CoₓMn_{y}O₂ (0<x<1, 0<y<1, 0<x+y<1). In these lithium-containing compound oxides, a part of metal elements such as Co, Ni and Mn may be replaced by at least one metal element such as Mg, Al, Zr, Ti or Cr.

Examples of iron compound oxide are LiFeO₂ and LiFePO₄, and an example of vanadium compound oxide is V₂O₅.

Among the above-mentioned compound oxides, nickel compound oxides or cobalt compound oxides are preferred as an active material for a positive electrode from the viewpoint that capacity can be made high. Especially in a small size lithium ion secondary cell, the use of cobalt compound oxides is desirable from the viewpoint of high energy density and safety.

In the present invention, especially for the uses on large size lithium secondary cells for hybrid cars and distributed power source, since high output is demanded, it is preferable that particles of an active material for a positive electrode mainly comprise secondary particles, and an average particle size of the secondary particles is not more than 40 μm and fine particles having an average primary particle size of not more than 1 μm are contained in an amount of from 0.5 to 7.0% by volume.

When fine particles having an average primary particle size of not more than 1 μm are contained, an area thereof coming into contact with an electrolytic solution is increased and lithium ion can be scattered more rapidly between the electrode and the electrolytic solution, thereby enabling output performance to be improved.

An example of an active material to be used on a negative electrode in the present invention is carbon materials, and in addition, metallic oxides and metallic nitrides to which lithium ion can be inserted. Examples of carbon materials are natural graphite, artificial graphite, pyrocarbon, coke, mesocarbon microbeads, carbon fiber, activated carbon and pitch-coated graphite. Examples of metallic oxides to which lithium ion can be inserted are tin- or silicon- or titanium-containing metallic compounds, for example, tin oxide, silicon oxide and lithium titanate, and examples of metallic nitrides are Li_{2.6}Co_{0.4}N, etc.

A separator which can be used in the present invention is not limited particularly, and there are exemplified microporous polyethylene films, microporous polypropylene films, microporous ethylene-propylene copolymer films, microporous polypropylene/polyethylene two-layer films, microporous polypropylene/polyethylene/polypropylene three-layer films, etc. Also, there are films prepared by coating aramid resin on a separator or films prepared by coating a resin comprising polyamide imide and alumina filler on a separator which are made for the purpose of enhancing safety such as prevention of short-circuit due to Li dendrite.

The lithium secondary cell of the present invention are useful as a large size lithium secondary cell for hybrid cars and distributed power source, and in addition, are useful as a small size lithium secondary cell for a mobile phone and a portable remote terminal.

### EXAMPLE

The present invention is then explained by means of examples, but the present invention is not limited to them.

Compounds used in the following examples and comparative examples are as follows.

### Component (I)

(IA-1): HCF₂CF₂CH₂OCF₂CF₂H
(IA-2): HCF₂CF₂CH₂OCF₂CFHCF₃
(IA-3): CF₃CF₂CH₂OCF₂CF₂H
(IB-1): CF₃COOCH₂CF₂CF₂H
(IC-1): CF₃CH₂OCOOCH₂CF₃
(IC-2): CF₃CH₂OCOOCH₃

### Component (II)

(IIA): Fluorobenzene
(IIB): Trifluoromethyl benzene
(IIC): 1,4-difluorobenzene
(IID): Perfluorobenzene
(IIE): 3,5-difluoroanisole
(IIF): 4,4-difluorobiphenyl

### Component (IIIA)

(IIIA-1): Ethylene carbonate
(IIIA-2): Propylene carbonate
(IIIA-3): 4-fluoro-1,3-dioxolan-2-one

### Component (IIIB)

(IIIB-1): Dimethyl carbonate
(IIIB-2): Methyl ethyl carbonate
(IIIB-3): Diethyl carbonate

### Component (IV)

(IVA): Cyclohexylbenzene

Electrolyte salt (V)
(VA): LiPF₆
(VB): LiN(SO₂CF₃)₂
(VC): LiN(SO₂C₂F₅)₂
(VD): LiBF₄

### Example 1

HCF₂CF₂CH₂OCF₂CF₂H (IA-1) as the component (I), fluorobenzene (IIA) as the component (II), ethylene carbonate (IIIA-1) as the component (IIIA) and dimethyl carbonate (IIIB-1) as the component (IIIB) were mixed in the volume % ratio of 40/0.5/20/39.5, and to this solvent for dissolving an electrolyte salt was added LiPF₆ as the electrolyte salt to give 1.0 mole/liter of its concentration, followed by sufficiently stirring at 25° C. Thus, the non-aqueous electrolytic solution of the present invention was prepared.

### Example 2

The non-aqueous electrolytic solution of the present invention was prepared in the same manner as in Example 1 except that trifluoromethyl benzene (IIB) was used as the component (II) in an amount of 5% by volume, dimethyl carbonate (IIIB-1) was used in an amount of 35% by volume, and the volume % ratio of (I)/(IIB)/(IIIA-1)/(IIIB-1) was changed to 40/5/20/35.

### Comparative Example 1

A comparative non-aqueous electrolytic solution was prepared in the same manner as in Example 1 except that HCF₂CF₂CH₂OCF₂CF₂H (IA-1) as the component (I), ethylene carbonate (IIIA-1) as the component (IIIA) and dimethyl carbonate (IIIB-1) as the component (IIIB) were mixed in the volume % ratio of (IA-1)/(IIIA-1)/(IIIB-1) of 40/20/40, and no component (II) was added.

### Comparative Example 2

HCF₂CF₂CH₂OCF₂CF₂H (IA-1) as the component (I), cyclohexylbenzene (IVA) instead of the component (II), ethylene carbonate (IIIA-1) as the component (IIIA) and dimethyl carbonate (IIIB-1) as the component (IIIB) were mixed in the volume % ratio of (I)/(IV)/(IIIA-1)/(IIIB-1) of 40/0.5/20/39.5, and to this solvent for dissolving an electrolyte salt was added LiPF₆ as the electrolyte salt to give 1.0 mole/liter of its concentration, followed by sufficiently stirring at 25° C. Thus, the non-aqueous electrolytic solution of the present invention was prepared.

The following Test 1 was carried out using these non-aqueous electrolytic solutions.

### Test 1 (Measurement of Calorific Value)

### (Preparation of Laminated Cell)

An active material for a positive electrode prepared by mixing LiCoO₂, carbon black and polyvinylidene fluoride (trade name KF-1000 available from KUREHA CORPORATION) in a ratio of 90/3/7 (mass percent ratio) was dispersed in N-methyl-2-pyrrolidone to be formed into a slurry which was then uniformly coated on a positive electrode current collector (15 μm thick aluminum foil) and dried to form a layer made of a mixture of positive electrode materials. Then, the coated aluminum foil was subjected to compression molding with a roller press, and after cutting, a lead wire was welded thereto to prepare a strip-like positive electrode.

Separately, a styrene-butadiene rubber dispersed in distilled water was added to artificial graphite powder (trade name MAG-D available from Hitachi Chemical Co., Ltd.) to give a solid content of 6% by mass, followed by mixing with a disperser to be formed into a slurry which was then uniformly coated on a negative electrode current collector (10 μm thick copper foil) and dried to form a layer made of a mixture of negative electrode materials. Then, the coated copper foil was subjected to compression molding with a roller press, and after cutting and drying, a lead wire was welded thereto to prepare a strip-like negative electrode.

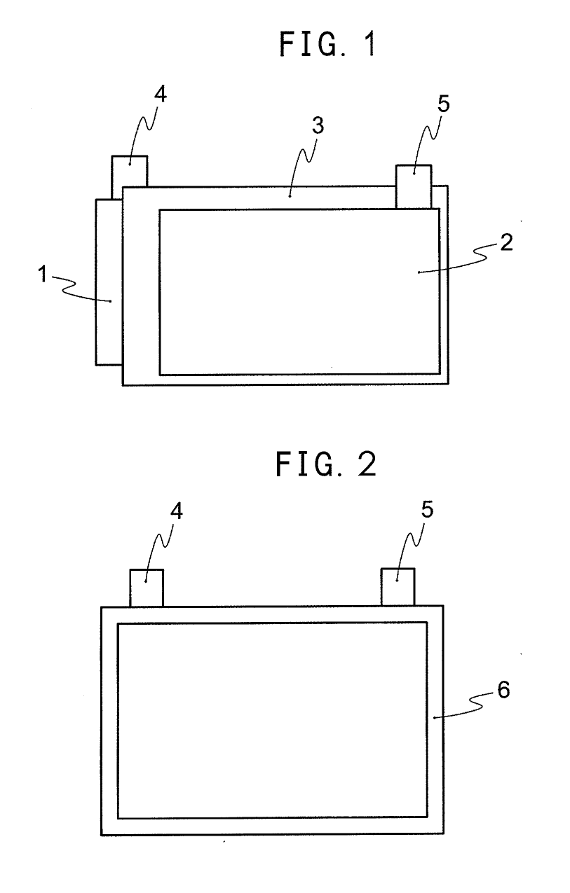

As shown in the diagrammatic perspective view of FIG. 1, the above strip-like positive electrode 1 was cut into a size of 40 mm×72 mm (with a 10 mm×10 mm positive electrode terminal 4), and the above strip-like negative electrode 2 was cut into a size of 42 mm×74 mm (with a 10 mm×10 mm negative electrode terminal 5). A lead wire was welded to each terminal. A 20 μm thick microporous polyethylene film was cut into a size of 78 mm×46 mm to make a separator 3, and the positive electrode and negative electrode were set so as to sandwich the separator between them. These were put in the aluminum-laminated casing 6 as shown in FIG. 2, and then 2 ml each of the electrolytic solutions prepared in Examples 1 and 2 and Comparative Examples 1 and 2 was poured into the casing 6, followed by sealing to make a laminated cell having a capacity of 72 mAh.

Charge/discharge cycle was such that charging of the cell was continued at 1.0 C at 4.2 V until a charging current reached 1/10 C, discharging was continued at a current equivalent to 0.2 C until 3.0 V was reached, and subsequently, charging of the cell was continued at 1.0 C at 4.2 V until a charging current reached 1/10 C.

After charging and discharging, the laminated cell was disassembled in a glow box, and the positive electrode was taken out. The positive electrode and 0.5 ml of the electrolytic solution of Example 1 or 2 or Comparative Example 1 or 2 were put in a cell for measurement of calorific value to make a calorific value measuring cell.

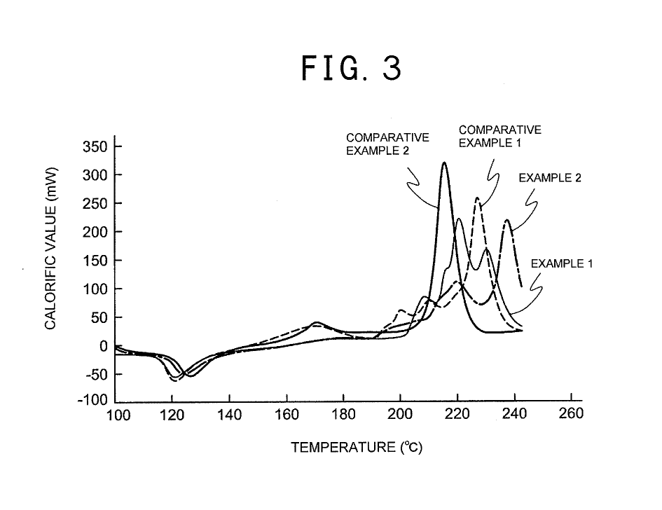

The calorific value measuring cell was set on a calorimeter C80 available from Setaram Instrumentation, and the cell was heated up to 100° C. to 250° C. at a temperature elevating rate of 0.5° C./min to measure calorific value. The results are shown in FIG. 3. From the results shown in FIG. 3, when comparing the electrolytic solutions of Examples 1 and 2 with the electrolytic solutions of Comparative Examples 1 and 2, it is seen that the electrolytic solutions of Examples 1 and 2 are safe since its heat generation starting temperature (peak around 150° C.) is higher and the total calorific value is smaller.

### Examples 3 to 6

Non-aqueous electrolytic solutions of the present invention were prepared in the same manner as in Example 1 except that amounts of the component (IA), component (IIA), component (IIIA-1) and component (IIIB-1) were changed as shown in Table 1.

Any of the obtained solvents for dissolving an electrolyte salt were low in viscosity, and mixing thereof with an electrolyte salt was easy.

### Comparative Example 3

A comparative non-aqueous electrolytic solution was prepared in the same manner as in Example 1 except that no component (I) was added, and the component (IIA), the component (IIIA-1) and the component (IIIB-1) were mixed in the volume % ratio of (IIA)/(IIIA-1)/(IIIB-1) of 0.5/30/69.5.

### Comparative Example 4

A comparative non-aqueous electrolytic solution was prepared in the same manner as in Example 1 except that HCF₂CF₂CH₂OCF₂CF₂H (IA-1) as the component (I), ethylene carbonate (IIIA-1) as the component (IIIA) and dimethyl carbonate (IIIB-1) as the component (IIIB) were mixed in the volume % ratio of (IA-1)/(IIIA-1)/(IIIB-1) of Oct. 20, 1970, and no component (II) was added.

### Examples 7 to 10

Non-aqueous electrolytic solutions of the present invention were prepared in the same manner as in Example 1 except that the following (IIC), (IID), (IIE) and (IIF) were used as the component (II) as shown in Table 2.

### (IIC): 1,4-Difluorobenzene

### (IID): Perfluorobenzene

### (IIE): 3,5-Difluoroanisole

### 4,4-Difluorobiphenyl

### Examples 11 to 14

Non-aqueous electrolytic solutions of the present invention were prepared in the same manner as in Example 1 except that the following (IA-2), (IA-3), (IB-1) and (IC-1) were used as the component (I) as shown in Table 3.

### (IA-2): HCF₂CF₂CH₂OCF₂CFHCF₃

### (IA-3): CF₃CF₂CH₂OCF₂CF₂H

### (IB-1): CF₃COOCH₂CF₂CF₂H

### (IC-1): CF₃CH₂OCOOCH₂CF₃

### Examples 15 to 20

Non-aqueous electrolytic solutions of the present invention were prepared in the same manner as in Example 1 except that combination of the component (IIIA) and the component (IIIB) was changed to that shown in Table 4.

### Examples 21 to 23

Non-aqueous electrolytic solutions of the present invention were prepared in the same manner as in Example 1 except that LiN(O₂SCF₃)₂, LiN(O₂SC₂F₅)₂ or LiBF₄ was used as an electrolyte salt instead of LiPF₆ as shown in Table 5.

### Examples 24 to 31

Non-aqueous electrolytic solutions of the present invention were prepared in the same manner as in Example 1 except that each component shown in Table 6 was used.

### Test 2 (Measurement of Cell Characteristics)

A cylindrical secondary cell was made by the following method.

The strip-like positive electrode made in Test 1 was placed on the strip-like negative electrode made in Test 1 with a 20 μm thick microporous polyethylene film (separator) being sandwiched between them, followed by winding spirally to make a laminated electrode of spiral-wound structure. In this case, winding was carried out so that the un-coated surface of the positive electrode current collector faces outward. After this, the laminated electrode was put in a cylindrical bottomed cell case having an outer diameter of 18 mm, and welding of lead wires for the positive electrode and negative electrode was carried out.

Then, electrolytic solutions prepared in Examples and Comparative Examples were poured into the cell case, and after the electrolytic solution had been sufficiently penetrated in the separator, etc., sealing of the case, pre-charging and aging were carried out to make cylindrical lithium secondary cells.

Discharge capacity, rate characteristic, cycle characteristic and safety at over-charging of these lithium secondary cells were determined by the following methods. The results of Examples 1 and 3 to 6 and Comparative Examples 1 to 4 are shown in Table 1, the results of Examples 1, 2 and 7 to 10 are shown in Table 2, the results of Examples 11 to 14 are shown in Table 3, the results of Examples 15 to 20 are shown in Table 4 and the results of Examples 21 to 23 are shown in Table 5.

### (Discharge Capacity)

When a charge/discharging current is represented by C and 1 C is assumed to be 1,800 mA, discharge capacity is measured under the following charge/discharge measuring conditions. Discharge capacity is indicated by an index, assuming the result of the discharge capacity of Comparative Example 3 to be 100.

### Charge and Discharge Conditions

Charging: Charging is continued at 1.0 C at 4.2 V until a charging current reaches 1/10 C(CC.CV charge).
Discharging: 1 C, 3.0 V cut (CC discharge)

### (Rate Characteristic)

Charging is continued at 1.0 C at 4.2 V until a charging current reaches 1/10 C, and discharging is continued at a current equivalent to 0.2 C until a voltage of 3.0 V is reached, and then discharge capacity is determined. Subsequently, charging is continued at 1.0 C at 4.2 V until a charging current reaches 1/10 C, and discharging is continued at a current equivalent to 2 C until a voltage of 3.0 V is reached, and then discharge capacity is determined. The discharge capacity at 2 C and the discharge capacity at 0.2 C are substituted in the following equation to obtain a rate characteristic.

Rate characteristic (%)=Discharge capacity (mAh) at 2 C/Discharge capacity (mAh) at 0.2 C×100

### (Cycle Characteristic)

Charge and discharge cycle to be conducted under the above-mentioned charge and discharge conditions (Charging is continued at 1.0 C at 4.2 V until a charging current reaches 1/10 C, and discharging is continued at a current equivalent to 1 C until a voltage of 3.0 V is reached) is assumed to be one cycle, and discharge capacity after the first cycle and discharge capacity after the hundredth cycle are measured. Cycle characteristic is represented by a cycle maintenance factor obtained by the following equation.

Cycle maintenance factor (%)=Discharge capacity (mAh) after the hundredth cycle/Discharge capacity (mAh) after the first cycle×100

### (Over-Charge Test 1)

The cylindrical cells of Examples and Comparative Examples are discharged at a current equivalent to 1 CmA until a voltage of 3.0 V is reached, and over-charging is carried out at a current equivalent to 1 CmA with determining the upper limit voltage to 12V, and whether or not firing or bursting occurs is examined. When firing or bursting occurs, it is shown by X, and when neither firing nor bursting occurs, it is shown by ◯.

### (Over-Charge Test 2)

After the cylindrical cells of Examples and Comparative Examples are discharged up to 3.0 V at a current equivalent to 1 CmA, then over-charging is carried out at a current equivalent to 3 CmA with determining the upper limit voltage to 12V, and whether firing or bursting occurs is examined. When firing or bursting occurs, it is shown by X, and when neither firing nor bursting occurs, it is shown by ◯.

### (Over-Charge Test 3)

After the cylindrical cells of Examples and Comparative Examples are discharged up to 3.0 V at a current equivalent to 1 CmA, the cells are wound with glass wool, and then over-charging is carried out at a current equivalent to 1 CmA with determining the upper limit voltage to 12V, and whether firing or bursting occurs is examined. When firing or bursting occurs, it is shown by X, and when neither firing nor bursting occurs, it is shown by ◯.

TABLE 1

| | Example | | | | | Comparative Example | | | |
|---|---|---|---|---|---|---|---|---|---|
| | 1 | 3 | 4 | 5 | 6 | 1 | 2 | 3 | 4 |
| Electrolytic solution | | | | | | | | | |
| Solvent components | | | | | | | | | |
| Component (I) | | | | | | | | | |
| Kind | IA-1 | IA-1 | IA-1 | IA-1 | IA-1 | IA-1 | IA-1 | — | IA-1 |
| Proportion (volume %) | 40 | 10 | 60 | 40 | 40 | 40 | 40 | — | 10 |
| Component (II) | | | | | | | | | |
| Kind | IIA | IIA | IIA | IIA | IIA | — | — | IIA | — |
| Proportion (volume %) | 0.5 | 0.5 | 0.5 | 10 | 5 | — | — | 0.5 | — |
| Component (IIIA) | | | | | | | | | |
| Kind | IIIA-1 | IIIA-1 | IIIA-1 | IIIA-1 | IIIA-1 | IIIA-1 | IIIA-1 | IIIA-1 | IIIA-1 |
| Proportion (volume %) | 20 | 20 | 20 | 20 | 20 | 20 | 20 | 30 | 20 |
| Component (IIIB) | | | | | | | | | |
| Kind | IIIB-1 | IIIB-1 | IIIB-1 | IIIB-1 | IIIB-1 | IIIB-1 | IIIB-1 | IIIB-1 | IIIB-1 |
| Proportion (volume %) | 39.5 | 69.5 | 19.5 | 30 | 35 | 40 | 39.5 | 69.5 | 70 |
| Component (IV) | | | | | | | | | |
| Kind | — | — | — | — | — | — | IV | — | — |
| Proportion (volume %) | — | — | — | — | — | — | 0.5 | — | — |
| Electrolyte salt (mole/liter) | | | | | | | | | |
| LiPF₆ | 1.0 | 1.0 | 1.0 | 1.0 | 1.0 | 1.0 | 1.0 | 1.0 | 1.0 |
| Discharge capacity (index) | 107.2 | 106.8 | 105.9 | 106.3 | 106.8 | 107.0 | 98.5 | 100.0 | 106.9 |
| Rate characteristic (%) | 92.5 | 92.5 | 91.5 | 92.1 | 92.2 | 92.3 | 89.5 | 89.1 | 92.7 |
| Cycle characteristic (%) | 95.8 | 95.5 | 95.5 | 94.8 | 95.5 | 96.0 | 93.3 | 87.1 | 95.6 |
| Over-charge test 1 | ◯ | ◯ | ◯ | ◯ | ◯ | ◯ | ◯ | X | X |
| Over-charge test 2 | ◯ | X | ◯ | ◯ | ◯ | ◯ | ◯ | X | X |
| Over-charge test 3 | ◯ | X | ◯ | ◯ | ◯ | X | X | X | X |

From the results of Table 1, it is seen that when the fluorine-containing aromatic compound (fluorobenzene) is added in various amounts, discharge capacity, rate characteristic and cycle characteristic are improved more as compared with those of Comparative Example 1 where such a compound is not added. Also, it is seen that there is exhibited a large effect on discharge capacity, rate characteristic and cycle characteristic as compared with Comparative Example 2 in which cyclohexylbenzene was added instead of the fluorine-containing aromatic compound and Comparative Example 3 in which the component (I) was not blended. Even in the case of 10% by volume of the component (IA-1), safety is improved by adding a very small amount of component (IIA) as compared with Comparative Example 4. From the results of over-charge tests, it is seen that safety of the cells of Examples is further improved.

TABLE 2

Example

| | 1 | 2 | 7 | 8 | 9 | 10 |
|---|---|---|---|---|---|---|
| Electrolytic solution | | | | | | |
| Solvent components | | | | | | |
| Component (I) | | | | | | |
| Kind | IA-1 | IA-1 | IA-1 | IA-1 | IA-1 | IA-1 |
| Proportion (volume %) | 40 | 40 | 40 | 40 | 40 | 40 |
| Component (II) | | | | | | |
| Kind | IIA | IIB | IIC | IID | IIE | IIF |
| Proportion (volume %) | 0.5 | 5 | 0.5 | 0.5 | 0.5 | 0.5 |
| Component (IIIA) | | | | | | |
| Kind | IIIA-1 | IIIA-1 | IIIA-1 | IIIA-1 | IIIA-1 | IIIA-1 |
| Proportion (volume %) | 20 | 20 | 20 | 20 | 20 | 20 |
| Component (IIIB) | | | | | | |
| Kind | IIIB-1 | IIIB-1 | IIIB-1 | IIIB-1 | IIIB-1 | IIIB-1 |
| Proportion (volume %) | 39.5 | 35 | 39.5 | 39.5 | 39.5 | 39.5 |
| Electrolyte salt (mole/liter) | | | | | | |
| LiPF₆ | 1.0 | 1.0 | 1.0 | 1.0 | 1.0 | 1.0 |
| Discharge capacity (index) | 107.2 | 106.5 | 106.5 | 103.5 | 107.2 | 106.5 |
| Rate characteristic (%) | 92.5 | 92.0 | 91.5 | 90.8 | 92.5 | 92.1 |
| Cycle characteristic (%) | 95.8 | 95.2 | 94.2 | 95.8 | 95.8 | 95.4 |
| Over-charge test 1 | ◯ | ◯ | ◯ | ◯ | ◯ | ◯ |
| Over-charge test 2 | ◯ | ◯ | ◯ | ◯ | ◯ | ◯ |
| Over-charge test 3 | ◯ | ◯ | ◯ | ◯ | ◯ | ◯ |

From the results of Table 2, it is seen that even if a kind of the fluorine-containing aromatic compound is changed, discharge capacity, rate characteristic and cycle characteristic are improved more than those of Comparative Example 3. Also, from the results of the over-charge tests, it is seen that safety is further improved.

TABLE 3

| | Example | | | |
|---|---|---|---|---|
| | 11 | 12 | 13 | 14 |
| Electrolytic solution | | | | |
| Solvent components | | | | |
| Component (I) | | | | |
| Kind | IA-2 | IA-3 | IB-1 | IC-1 |
| Proportion (volume %) | 40 | 40 | 40 | 40 |
| Component (II) | | | | |
| Kind | IIA | IIA | IIA | IIA |
| Proportion (volume %) | 0.5 | 0.5 | 0.5 | 0.5 |
| Component (IIIA) | | | | |
| Kind | IIIA-1 | IIIA-1 | IIIA-1 | IIIA-1 |
| Proportion (volume %) | 20 | 20 | 20 | 20 |
| Component (IIIB) | | | | |
| Kind | IIIB-1 | IIIB-1 | IIIB-1 | IIIB-1 |
| Proportion (volume %) | 39.5 | 39.5 | 39.5 | 39.5 |
| Electrolyte salt (mole/liter) | | | | |
| LiPF₆ | 1.0 | 1.0 | 1.0 | 1.0 |
| Discharge capacity (index) | 105.9 | 105.6 | 104.0 | 104.6 |
| Rate characteristic (%) | 92.5 | 92.4 | 93.7 | 92.8 |
| Cycle characteristic (%) | 95.8 | 95.6 | 95.4 | 95.1 |
| Over-charge test 1 | ◯ | ◯ | ◯ | ◯ |
| Over-charge test 2 | ◯ | ◯ | ◯ | ◯ |
| Over-charge test 3 | ◯ | ◯ | ◯ | ◯ |

From the results of Table 3, it is seen that even if a fluorine-containing ether is changed to a fluorine-containing ester or a fluorine-containing cyclic carbonate, discharge capacity, rate characteristic and cycle characteristic are improved more than those of Comparative Example 3. Also, from the results of the over-charge tests, it is seen that safety is further improved.

TABLE 4

| | Example | | | | | |
|---|---|---|---|---|---|---|
| | 15 | 16 | 17 | 18 | 19 | 20 |
| Electrolytic solution | | | | | | |
| Solvent components | | | | | | |
| Component (I) | | | | | | |
| Kind | IA-1 | IA-1 | IA-1 | IA-1 | IA-1 | IA-1 |
| Proportion (volume %) | 40 | 40 | 40 | 40 | 40 | 40 |
| Component (II) | | | | | | |
| NKind | IIA | IIA | IIA | IIA | IIA | IIA |
| Proportion (volume %) | 0.5 | 0.5 | 0.5 | 0.5 | 0.5 | 0.5 |
| Component (IIIA) | | | | | | |
| Kind | IIIA-1 + IIIA-2 | IIIA-1 | IIIA-1 | IIIA-1 | IIIA-1 | IIIA-1 |
| Proportion (volume %) | 20 + 10 | 20 | 20 | 20 | 20 | 20 |
| Component (IIIB) | | | | | | |
| Kind | IIIB-1 | IIIB-2 | IIIB-3 | IIIB-1 + IIIB-2 | IIIB-1 + IIIB-3 | IIIB-2 + IIIB-3 |
| Proportion (volume %) | 29.5 | 39.5 | 39.5 | 20 + 19.5 | 20 + 19.5 | 20 + 19.5 |
| Electrolyte salt (mole/liter) | | | | | | |
| LiPF₆ | 1.0 | 1.0 | 1.0 | 1.0 | 1.0 | 1.0 |
| Discharge capacity (index) | 106.7 | 106.8 | 106.4 | 106.8 | 106.6 | 106.5 |
| Rate characteristic (%) | 92 | 92.1 | 91.8 | 92.1 | 91.8 | 91.5 |
| Cycle characteristic (%) | 95.6 | 95.5 | 96.1 | 95.7 | 95.5 | 95.8 |
| Over-charge test 1 | ◯ | ◯ | ◯ | ◯ | ◯ | ◯ |
| Over-charge test 2 | ◯ | ◯ | ◯ | ◯ | ◯ | ◯ |

From the results of Table 4, it is seen that even if a kind of a chain carbonate is changed, two or more chain carbonates are mixed or two or more cyclic carbonates are mixed, discharge capacity, rate characteristic and cycle characteristic are improved more than those of Comparative Example 3. Also, from the results of the over-charge tests, it is seen that safety is further improved.

TABLE 5

| | Example | | |
|---|---|---|---|
| | 21 | 22 | 23 |
| Electrolytic solution | | | |
| Solvent components | | | |
| Component (I) | | | |
| Kind | IA-1 | IA-1 | IA-1 |
| Proportion (volume %) | 40 | 40 | 40 |
| Component (II) | | | |
| Kind | IIA | IIA | IIA |
| Proportion (volume %) | 0.5 | 0.5 | 0.5 |
| Component (IIIA) | | | |
| Kind | IIIA-1 | IIIA-1 | IIIA-1 |
| Proportion (volume %) | 20 | 20 | 20 |
| Component (IIIB) | | | |
| Kind | IIIB-1 | IIIB-1 | IIIB-1 |
| Proportion (volume %) | 39.5 | 39.5 | 39.5 |
| Electrolyte salt (mole/liter) | | | |
| LiPF₆ | — | — | — |
| LiN(SO₂CF₃)₂ | 1.0 | — | — |
| LiN(SO₂C₂F₅)₂ | — | 1.0 | — |
| LiBF₄ | — | — | 1.0 |
| Discharge capacity (index) | 106.7 | 106.5 | 106.8 |
| Rate characteristic (%) | 92.3 | 92.1 | 92.4 |
| Cycle characteristic (%) | 95.5 | 95.3 | 94.8 |
| Over-charge test 1 | ◯ | ◯ | ◯ |
| Over-charge test 2 | ◯ | ◯ | ◯ |

From the results of Table 5, it is seen that even if an electrolyte salt is changed, discharge capacity, rate characteristic and cycle characteristic are improved more than those of Comparative Example 3. Also, from the results of the over-charge tests, it is seen that safety is further improved.

TABLE 6

| | Example | | | |
|---|---|---|---|---|
| | 24 | 25 | 26 | 27 |
| Electrolytic solution | | | | |
| Solvent components | | | | |
| Component (I) | | | | |
| Kind | IC-2 | IA-1 | IA-1 + IC-2 | IA-1 + IC-2 |
| Proportion (volume %) | 30 | 20 | 20 + 20 | 20 + 20 |
| Component (II) | | | | |
| Kind | IIA | IIA | IIA | IIB |
| Proportion (volume %) | 0.5 | 2 | 2 | 2 |
| Component (IIIA) | | | | |
| Kind | IIIA-1 + IIIA-3 | IIIA-3 | IIIA-3 | IIIA-3 |
| Proportion (volume %) | 15 + 5 | 20 | 20 | 20 |
| Component (IIIB) | | | | |
| Kind | IIIB-1 | IIIB-1 | IIIB-1 | IIIB-1 |
| Proportion (volume %) | 49.5 | 58 | 38 | 38 |
| Electrolyte salt (mole/liter) | | | | |
| LiPF₆ | 1.0 | 1.0 | 1.0 | 1.0 |
| Discharge capacity (index) | 101.5 | 103.2 | 102.5 | 101.2 |
| Rate characteristic (%) | 91 | 93 | 91.2 | 90.8 |
| Cycle characteristic (%) | 94.2 | 95.1 | 94.3 | 95.1 |
| Over-charge test 1 | ◯ | ◯ | ◯ | ◯ |
| Over-charge test 2 | ◯ | ◯ | ◯ | ◯ |

| | Example | | | |
|---|---|---|---|---|
| | 28 | 29 | 30 | 31 |
| Electrolytic solution | | | | |
| Solvent components | | | | |
| Component (I) | | | | |
| Kind | IA-1 + IC-2 | IA-1 | IA-1 + IC-2 | IA-1 + IC-2 |
| Proportion (volume %) | 20 + 20 | 30 | 20 + 10 | 10 + 30 |
| Component (II) | | | | |
| Kind | IIE | IIC | IID | IIF |
| Proportion (volume %) | 2 | 2 | 2 | 0.5 |
| Component (IIIA) | | | | |
| Kind | IIIA-3 | IIIA-1 + IIIA-3 | IIIA-1 + IIIA-3 | IIIA-1 + IIIA-3 |
| Proportion (volume %) | 20 | 15 + 5 | 15 + 5 | 15 + 5 |
| Component (IIIB) | | | | |
| Kind | IIIB-1 | IIIB-1 | IIIB-1 | IIIB-1 |
| Proportion (volume %) | 38 | 48 | 48 | 39.5 |
| Electrolyte salt (mole/liter) | | | | |
| LiPF₆ | 1.0 | 1.0 | 1.0 | 1.0 |
| Discharge capacity (index) | 102.5 | 102.2 | 103.1 | 102.1 |
| Rate characteristic (%) | 91.1 | 91.1 | 91.2 | 91.5 |
| Cycle characteristic (%) | 94.3 | 93.5 | 92.6 | 92.1 |
| Over-charge test 1 | ◯ | ◯ | ◯ | ◯ |
| Over-charge test 2 | ◯ | ◯ | ◯ | ◯ |

From the results of Table 6, it is seen that even in the cases of various combinations of the components (I) to (III), discharge capacity, rate characteristic and cycle characteristic are improved more than those of Comparative Example 3. Also, from the results of the over-charge tests, it is seen that safety is further improved.

### EXPLANATION OF SYMBOLS

1 Positive electrode
2 Negative electrode
3 Separator
4 Positive electrode terminal
5 Negative electrode terminal
6 Aluminum-laminated casing

1. A solvent for dissolving an electrolyte salt of a lithium secondary cell, comprising at least one fluorine-containing solvent (I) selected from the group consisting of fluorine-containing ether, fluorine-containing ester and fluorine-containing chain carbonate, a fluorine-containing aromatic compound (II), in which a part or the whole of hydrogen atoms are replaced by fluorine atoms, and other carbonate (III),
wherein the fluorine-containing solvent (I) is at least one selected from the group consisting of:
a fluorine-containing ether represented by the formula (IA):
Rf¹ORf²
wherein Rf¹ is a fluorine-containing alkyl group having 3 to 6 carbon atoms, Rf² is a fluorine-containing alkyl group having 2 to 6 carbon atoms,
a fluorine-containing ester represented by the formula (IB):
Rf³COORf⁴
wherein Rf³ is an alkyl group which has 1 or 2 carbon atoms and may have fluorine atom, Rf⁴ is an alkyl group which has 1 to 4 carbon atoms and may have fluorine atom, at least either Rf³ or
Rf⁴ is a fluorine-containing alkyl group, and
a fluorine-containing chain carbonate represented by the formula (IC):
Rf⁵OCOORf⁶
wherein Rf⁵ is a fluorine-containing alkyl group having 1 to 4 carbon atoms, Rf⁶ is an alkyl group which has 1 to 4 carbon atoms and may have fluorine atom, and
wherein the fluorine-containing aromatic compound (II) is contained in an amount of 1 to 5% by volume.

2. (canceled)

3. The solvent of claim 1, wherein the other carbonate (III) is a cyclic carbonate (IIIA) and a non-fluorine-containing chain carbonate (IIIB).

4. The solvent of claim 3, wherein the cyclic carbonate (IIIA) is one of ethylene carbonate, propylene carbonate and 4-fluoro-1,3-dioxolan-2-one or a mixture thereof.

5. The solvent of claim 3, wherein the non-fluorine-containing chain carbonate (IIIB) is one of dimethyl carbonate, methyl ethyl carbonate and diethyl carbonate or a mixture thereof.

6. The solvent of claim 1, wherein the fluorine-containing aromatic compound (II) is a fluorine-containing aromatic compound obtained by replacing a part or the whole of hydrogen atoms of benzene, toluene, xylene, anisole or biphenyl by fluorine atoms.

7. The solvent of claim 6, wherein the fluorine-containing aromatic compound (II) is monofluorobenzene, difluorobenzene, perfluorobenzene, trifluoromethyl benzene, difluorotoluene, difluoroanisole or fluorobiphenyl.

8. The solvent of claim 1, wherein when the total amount of (I), (II) and (III) is assumed to be 100% by volume, the fluorine-containing solvent (I) is contained in an amount of 10 to 90% by volume.

9. The solvent of claim 3, wherein when the total amount of (I), (II), (IIIA) and (IIIB) is assumed to be 100% by volume, (I) is contained in an amount of 10 to 60% by volume, (II) is contained in an amount of 0.1 to 5% by volume, (IIIA) is contained in an amount of 10 to 50% by volume and (IIIB) is contained in an amount of 0 to 79.9% by volume.

10. A non-aqueous electrolytic solution of a lithium secondary cell comprising the solvent for dissolving an electrolyte salt of claim 1 and an electrolyte salt.

11. A lithium secondary cell using the non-aqueous electrolytic solution of claim 10.
